(19) United States
(12) Patent Application Publication
(10) Pub. No.: US 2009/0205607 A1
(43) Pub. Date: Aug. 20, 2009

(54) INTERNAL COMBUSTION ENGINE INCLUDING A PISTON WITH A GEOMETRICALLY-COMPLEX BOSS

(75) Inventor: Franck Levy, Guigneville sur Essonne (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S.A.S., Boulogne Billancourt (FR)

(21) Appl. No.: 12/094,658

(22) PCT Filed: Nov. 29, 2006
(86) PCT No.: PCT/FR06/51244

§ 371 Date: Aug. 27, 2008

(30) Foreign Application Priority Data
Dec. 8, 2005 (FR) 0553779

(51) Int. Cl. F02F 3/26; F02B 5/00

(52) U.S. Cl. 123/276; 123/305

(57) ABSTRACT

An engine including a cylinder including a sliding piston with a combustion bowl associated with an off-center injector. The injector sprays fuel in a conical injection pattern form having an apex and is formed by asymmetrical jets that travel different lengths before coming into contact with an inner wall of the bowl. The wall includes a groove centered on a main axis and connected to a base from which a boss extends. The boss includes: a lower cone frustum including a base included in a horizontal plane of the base and centered on the main axis of symmetry, having an apex as the symmetrical point of the apex of the injection pattern in relation to the main axis of symmetry; and an upper cone frustum including a base formed by an upper horizontal face of the lower cone frustum, having an apex corresponding to the injection pattern apex.

The invention relates to a direct injection internal combustion engine comprising a piston, the combustion bowl of which comprises a boss or “pip” of complex geometry.

Numerous examples of internal combustion engines of this type for motor vehicles are known, particularly for compression-ignition engines of the diesel engine type, for which performance enhancements are always being sought, through reductions in, on the one hand, their fuel consumption and, on the other hand, their emissions of pollutant substances such as oxides of nitrogen (NOx) or the soot particulates contained in the exhaust fumes leaving the tailpipe.

Improvements such as this can be obtained in particular by altering the quality of the mixing between the inlet gases and the fuel, that is to say by producing a substantially homogeneous mixture in the engine cylinder combustion chamber and more specifically in the piston combustion bowl.

In the case of a direct injection engine, the main phenomena involved and which make it possible to obtain a substantially homogeneous mixture are, in essence, the atomization of the fuel and air movements of the “swirl” type of the charge of inlet gas about an axis substantially coincident with or parallel to the axis of the cylinder, and also the movement of the air caused by the injection of fuel.

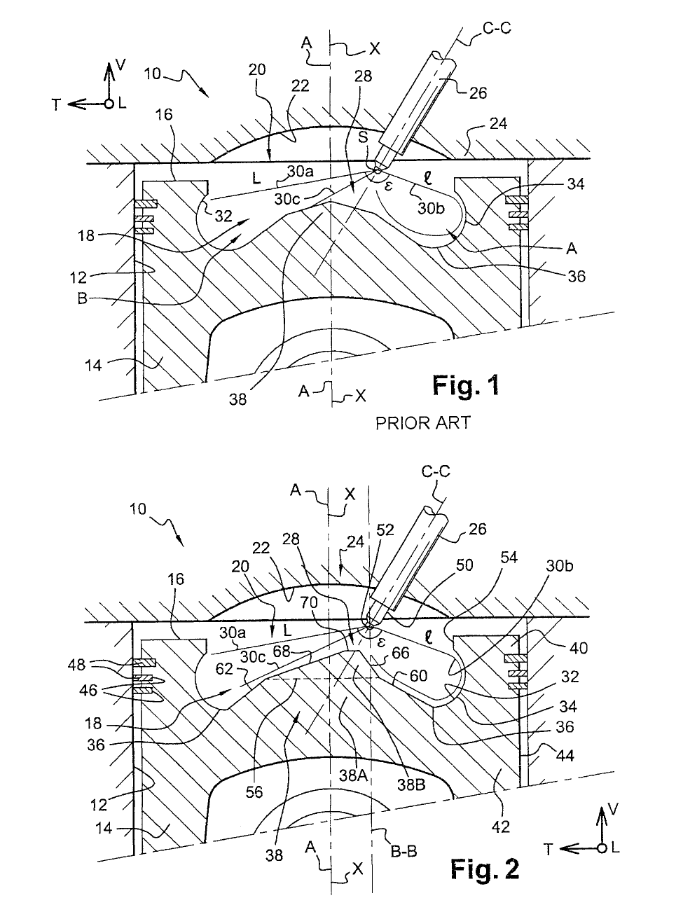

FIG. 1 depicts a direct injection internal combustion engine cylinder of the type described in document FR-A-2,844,012 which illustrates one example of the prior art.

The internal combustion engine 10 comprises at least one cylinder 12 of vertical axis X-X in which a piston 14 which, in its upper face 16, comprises a combustion bowl 18 delimiting the lower part of a combustion chamber 20 the upper part of which is delimited by a portion facing it belonging to the underside 22 of a cylinder head 24, slides axially, an injector 26 which is offset from the axis X-X of the cylinder 12 and which sprays the fuel in the form of an injected spray 28, substantially conical at the vertex S, which is made up of several asymmetric jets 30 which cover paths of differing lengths before coming into contact with the internal wall 32 of the combustion bowl 18 which consists of a lateral annular groove 34 centered on a main axis of symmetry A-A which meets a substantially horizontal bottom 36 from which a pip 38 extends vertically over a determined total height H.

It is known that, in an engine 10 such as this, the characteristics of the air/fuel mixture as obtained in the combustion chamber 20 are directly dependent on the width of the spray, known as the spray angle (ε) at which the fuel is injected into the combustion chamber 20 by the injector 26 and on the complementary geometry of the combustion bowl 18 associated with it.

The invention is concerned more specifically with engines in which the position of the fuel injector is offset from the vertical axis X-X of the cylinder, such as is generally the case with internal combustion engines comprising two valves per cylinder so as to allow a large-diameter inlet valve and exhaust valve to be installed for each cylinder.

When the injector is offset or off-centered in this way, the various jets of fuel are injected asymmetrically and this in particular has an effect on the quality of the mixture which is not as homogeneous as might be desired throughout the combustion bowl 18.

As can best be seen from FIG. 1, the various jets of fuel 30 are asymmetric in that they travel paths of different lengths, also known as “free travels”, before impinging on the internal wall 32 of the combustion bowl 18.

More specifically, a first fraction of the jets, termed the long jets 30a, travel a path or a distance “L”, whereas a second fraction of the jets 30b, termed the short jets 30b, travel a distance “l” and, finally, a third fraction of the jets 30c, termed the intermediate jets 30c, travel a mean distance ranging between L and l before all the jets of fuel 30a, 30b and 30c respectively impinge on the internal wall 32 of the groove 34.

Thus, the combustion bowl 18 has, on the one hand, a first region A predominantly fuel-rich attributable to the fact that the short jets 30b of length l are confined and wrap around themselves after they have impinged on the wall 32, thus causing the jets to overlap and, on the other hand, a second region B near the bottom 36 into which the long jets 30a of length L penetrate little and which is thus predominantly air-rich and fuel-lean.

As a result, the asymmetry in the jets of fuel 30 causes an imbalance between the distribution of fuel and inlet gases which means that a combustion bowl geometry such as this is unsatisfactory.

This is because a non-homogeneous air/fuel mixture gives rise to smoke in particular.

In addition, the pip 38 generally has a shape that exhibits symmetry of revolution centered on the main axis of symmetry A-A of the combustion bowl 18 which means that there is a substantial risk of interference between the asymmetric jets 30, particularly between the long jets 30a and the medium jets 30c, and the upper part of the pip 38.

In order to limit such risks of interference, proposals in particular have been made to alter the width of the injected spray by increasing the spray angle (ε). However, this is not a satisfactory solution because it has a large impact on the quality of the air/fuel mixture, particularly in the second region B that is predominantly air-rich and fuel-lean.

According to another known solution, it has been proposed that the volume of the pip be reduced in order to limit the risk of interference, but the volume of the combustion bowl then increases proportionately, this being to the detriment of the desired compression ratio that can then no longer be obtained.

Such solutions are therefore not satisfactory.

This is why attempts have been made to optimize, on the one hand, the geometry and location of the combustion bowls and of the pips and, on the other hand, the distribution of the jets of fuel sprayed by the associated injector.

It is an object of the invention to remedy these disadvantages and to propose an internal combustion engine comprising a piston the combustion bowl of which has a pip of complex geometry that makes it possible in particular to obtain an air/fuel mixture that is homogeneous throughout the bowl and in which there is no interference between the jets of fuel and the upper part of the pip.

To this end, the invention proposes an internal combustion engine for a motor vehicle of the type described hereinabove, characterized in that the pip consists:
of a lower cone frustum the base of which is contained in the horizontal plane of the bottom and is centered on the main axis of symmetry and the vertex of which is the point symmetric with the vertex of the injected spray with respect to the main axis of symmetry; and
of an upper cone frustum the base of which is formed by the upper horizontal face of the lower cone frustum and the vertex of which corresponds to the vertex of the injected spray through which a reference vertical axis passes.

By virtue of the invention, the exchanges between the injected fuel and the inlet gases of an internal combustion engine are improved and engine performance is improved while at the same time reducing the formation of pollutants, such as oxides of nitrogen (NOx), soot and other unburned hydrocarbons that form the black smoke leaving the tailpipe.

According to other features of the invention:
the lower cone frustum of the pip comprises a lower external wall with continuously varying convexness, comprising at least:
   a first portion of lower wall extending over a determined first angular sector, centered on the reference vertical axis, corresponding substantially to the angular sector of the injected spray formed by the shorter-length jets; and
   a second portion of lower wall extending over a determined second angular sector, centered on the reference vertical axis, corresponding substantially to the angular sector of the injected spray formed by the longer-length jets;
in cross section on a vertical plane of section passing through the main axis, the first portion of the lower wall has a straight inclined profile of which the gradient, termed the first gradient, lies in the continuation of the horizontal bottom and is determined in such a way as to prevent the shorter-length jets from curling up on themselves in the direction of the internal wall of the groove;
in cross section on a vertical plane of section passing through the main axis, the second portion of the lower wall has a straight inclined profile of which the gradient, termed the second gradient, is greater than the first gradient so that the volume of the lateral groove at least in the second angular sector is smaller than the volume of the lateral groove in the first angular sector;
the upper cone frustum of the pip has an upper outer wall of continuously variable convexness determined in such a way as to prevent interference between the jets of the injected spray and the upper external wall of the pip;
the height (h) of the upper horizontal face of the lower cone frustum is equal to half the total height of the pip from the bottom of the bowl to the top of the pip;
the total height of the pip is determined such that at the time of injection, there is no interference between the jets and the top of the pip;
the pip is produced by at least one milling operation performed on the piston;
the main axis of symmetry of the combustion bowl coincides with the vertical axis X-X of the cylinder;
the piston comprises angular indexing means to allow the piston to be mounted in the engine in a determined operating position that is indexed according to the parameters of the associated injected spray from the injector.

Other features and advantages of the invention will become apparent from reading the detailed description which follows, for an understanding of which reference will be made to the attached figures among which:

FIG. 1 is a schematic view in axial section of a cylinder of an internal combustion engine comprising a piston that has a combustion bowl according to the prior art;

FIG. 2 is a schematic view in axial section of a cylinder of an internal combustion engine similar to that of FIG. 1 comprising a piston equipped with a combustion bowl that has a pip of complex geometry according to the invention;

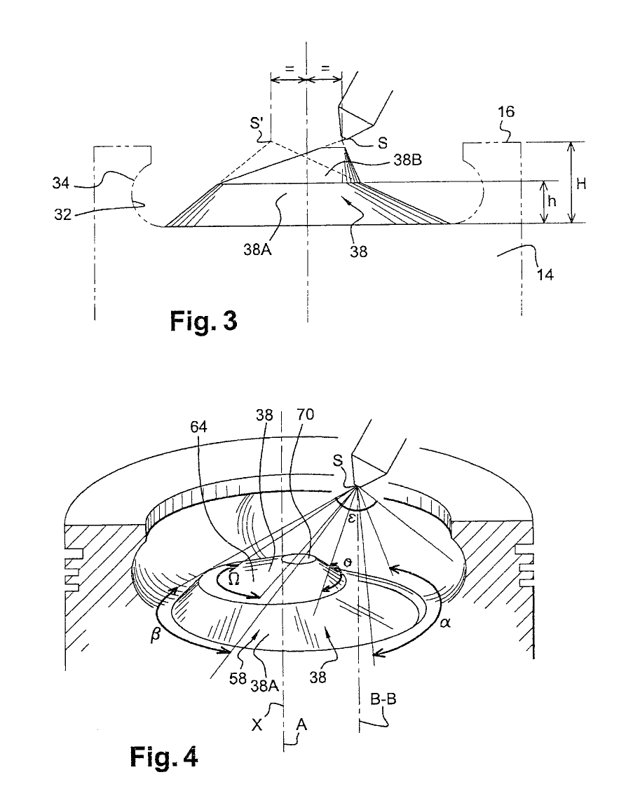

FIG. 3 is a schematic view in axial section of the combustion bowl of the piston according to FIG. 2 illustrating the theoretical construction cones that correspond respectively to the lower cone frustum and to the upper lower cone frustum the superposition of which yields the pip according to the invention;

FIG. 4 is a schematic perspective view depicting in detail the conical injected spray that complements the complex-geometry pip according to the invention.

In the description and the claims expressions such as “upper” and “lower” and directions “axially”, “vertical” and “lateral” will be employed nonlimitingly with reference to the figures and definitions given in the description.

In addition, elements which are identical, similar or analogous will be denoted by the same reference numerals.

FIG. 2 which depicts part of the internal combustion engine 10 of the direct injection type, and more particularly one 12 of the cylinders of the engine 10 will be described hereinafter by comparison with FIG. 1 that illustrates the prior art.

The cylinder 12 extends axially along a vertical axis of symmetry X-X and delimits an internal bore in which the piston 14 slides axially with a reciprocating movement.

The piston 14 axially comprises an upper crown 40 and a lower skirt 42, the external cylindrical wall 44 of the crown 40 comprising peripheral annular grooves 46 that house the piston rings 48.

The piston 14 comprises, in its upper horizontal face 16, the combustion bowl 18, also known as the cavity, which axially delimits the lower part of the combustion chamber 20 the upper part of which is delimited by a portion of the underside 22 of the cylinder head 24 of the engine.

The cylinder head 24 comprises at least one air inlet duct which opens via an inlet port closed off by an inlet valve (neither depicted) into the combustion chamber 20 and at least one exhaust duct for exhausting the burned gases and which opens via an outlet port intended to be closed off by an exhaust valve (not depicted) into the combustion chamber 20.

The cylinder head 24 bears at least one fuel injector 26 which is offset from the vertical axis X-X of the cylinder 12 so as in particular to allow large-diameter valves to be fitted.

The injector 26 is equipped with an injection tip 50 which opens directly into the combustion chamber 20 of the engine and comprises injection holes 52 for spraying the fuel toward the combustion bowl 18.

The holes 52 are, for example, arranged axially in a single row and distributed annularly with respect to the main axis C-C of the injector around the injection tip 50.

Advantageously, the number of holes 52 is greater than or equal to 6 and the holes 52 are preferably angularly distributed uniformly about the main axis C-C of the injector 26.

Advantageously, for fuel to be injected as close as possible to the axis X-X of the cylinder 12 in which the piston 14 slides, the tip 50 of the injector 26 is positioned here quite close to the axis X-X of the cylinder by angling the main axis C-C of the injector 26 with respect to the vertical axis X-X of the cylinder 12.

The fuel is sprayed through the holes 52 in the form of a substantially conical injected spray 28. The conical injected spray 28 is defined by a vertex S which in particular is determined according to the injection holes 52 and which here corresponds to an imaginary origin situated approximately at the end of the tip 50 of the injector 26.

The asymmetric jets 30 of fuel all extend from the vertex S in a solid spray angle (ε) that determines the width of the injected spray 28.

The combustion bowl 18 comprises a lateral annular groove 34 which is centered on a main axis of symmetry A-A.

The main axis of symmetry A-A here extends vertically, that is to say is coaxial with the axis X-X of the cylinder 12.

As a preference, the main axis of symmetry A-A of the combustion bowl 18 coincides with the vertical axis X-X of the cylinder 12 so that the combustion bowl 18 is centered with respect to the cylinder 12 and to the piston 14 of the engine 10.

The combustion bowl 18 comprises a substantially horizontal bottom 36 of constant depth from which the pip 38 extends vertically, or axially, over a determined total height H.

The term “depth” here means the axial dimension measured between the bottom 36 and the upper horizontal surface 16 of the piston 14 comprising the upper circular rim 54 which delimits the inlet opening of the bowl 18.

The upper circular rim 54, also sometimes known as the “lip” of the combustion bowl 18, here has a circular profile centered on the main axis of symmetry A-A.

As an alternative (which has not been depicted), the upper circular rim 54 has an asymmetric profile of the kind described in French patent application No. 0550156 filed by the applicant on Jan. 19, 2005 and not yet published.

The solid spray angle (ε) of the injected spray 28, of vertex S, is determined in particular on the basis of the geometric parameters of the associated combustion bowl 18, such as the diameter or the depth, and vice versa.

The asymmetric jets 30 cover, for example, a path length or distance 1 in the case of the short jets 30b and a longer length L in the case of the long jets 30a, that is to say paths of different lengths before they impinge on the internal wall 32 of the annular groove 34 of the combustion bowl 18.

By comparison with an injector 26 of the type that is centered on the axis A-A of the combustion bowl 18, the asymmetric jets 30 of an offset injector 26 are generally said to be long jets 30a when the length L of the path they travel is greater than the radius of the combustion bowl 18, are said to be short jets 30b when the length l of the path that they travel is shorter than the radius of the combustion bowl 18, and said to be medium jets 30c when the path that they cover is of a length somewhere between L and l substantially equal to the radius R of the combustion bowl 18.

According to the invention, the pip 38 is made up, on the one hand, of a lower cone frustum 38A the base of which is contained in the horizontal plane of the bottom 36 and is centered on the main axis of symmetry A-A and the vertex S′ of which is the point symmetric with the vertex S of the injected spray 28 with respect to the main axis of symmetry A-A and, on the other hand, of an upper cone frustum 38B the base 56 of which is formed by the upper horizontal face of the lower cone frustum 38A and the vertex of which corresponds to the vertex S of the injected spray 28 through which a reference vertical axis B-B passes.

FIG. 3 depicts the complex geometry pip 38 according to the invention in detail and illustrates the theoretical construction cones of vertex S′ and S that correspond to each of the cone frustums 38A and 38B that make up the pip 38.

As can best be seen in FIGS. 3 and 4, the lower cone frustum 38A of the pip 38 comprises a lower external wall 58 of constantly variable convexness comprising at least:
a first lower wall portion 60 extending over a determined first angular sector (α) substantially corresponding to the angular sector of the injected spray 28 formed by the shorter-length jets 30b, and
a second lower wall portion 62 extending over a determined second angular sector (β) substantially corresponding to the angular sector of the injected spray 28 formed by the longer-length jets 30a.

As a preference, the angular sectors (α) and (β) are centered on the reference vertical axis B-B passing through the vertex S of the conical injected spray 28.

Advantageously, the first portion 60 of the lower wall 58 has, in cross section on a vertical plane of section passing through the main axis A-A, an inclined profile of which the gradient, termed the first gradient, lies in the continuation of the horizontal bottom 36 and which is determined in such a way as to prevent the shorter-length jets 30b from wrapping round on themselves in the direction of the internal wall 32 of the lateral annular groove 34.

Similarly, the second lower wall portion 62 has, in cross section on a vertical plane of section passing through the main axis A-A, an inclined profile of which the gradient, termed the second gradient, is greater than the first gradient so that the volume of the lateral groove 34, at least in the second angular sector (β), is smaller than the volume of the lateral groove 34 in the first angular sector (α).

The respective inclined profiles of the first portion 60 and of the second portion 62 of the lower wall 58 are, in cross section, advantageously straight and obtained by milling.

The upper cone frustum 38B of the pip 38 comprises an upper external wall 64 of continuously variable convexness, that is to say that, in cross section on the successive vertical planes of section at successive angular positions about the axis A-A, the wall has an inclined profile the gradient of which varies continuously, particularly according to which angular sector is involved.

The convexness of the upper outer wall 64 is determined in such a way as to prevent interference between the jets 30 of the injected spray 28 and said upper outer wall 64 of the pip 38.

Thus, the upper outer wall 64 of the upper cone frustum 38B is advantageously wholly contained inside the volume of the cone formed by the asymmetric jets 30 of the injected spray 28 so as to prevent any interference between any one of the asymmetric jets 30a, 30b and 30c and the upper external wall 64 of the pip 38.

Advantageously, the upper external wall 64 of the upper cone frustum 38B of continuously variable convexness comprises at least:
a first portion 66 of upper wall 64 extending over a determined primary angular sector (θ) which substantially corresponds to the angular sector of the injected spray 28 formed by the shorter length jets 30b, and
a second portion 68 of upper wall 64 extending over a determined secondary angular sector (Ω) which substantially corresponds to the angular sector of the injected spray 28 formed by the longer-length jets 30a.

In cross section on a vertical plane of section passing through the main axis A-A, the first portion 66 of the upper wall 64 has an inclined profile of which the gradient, termed the third gradient, is determined in such a way as to lie wholly in the continuation of the first gradient of the first portion 60 of the lower wall 58 so as to allow the short jets 30b to develop from the internal wall 32 of the groove 34 toward the top of the pip 38.

In cross section on a vertical plane of section passing through the main axis A-A, the second portion 68 of the upper wall 64 has an inclined profile of which the gradient, termed the fourth gradient, is determined in such a way as to prevent interference with the jets 30, particularly with the long jets 30a and with the medium jets 30c of intermediate length.

The respective inclined profiles of the first portion 66 and of the second portion 68 of the upper outer wall 64 are advantageously straight and obtained by milling.

By virtue of the pip 38 according to the invention, the distribution of volume through the entire bowl 18 as a function in particular of the parameters of the injected spray 28 is optimized in such a way as to obtain an optimum compression ratio for a given total combustion bowl 18 volume.

By comparison with a combustion bowl 18 of the prior art as illustrated in FIG. 1, the complex-geometry pip 38 makes it possible, for the same volume, that is to say at equal volume, to obtain an optimum mixing of the air and of the fuel.

Specifically, the pip 38 has, centrally about the axis X-X, a greater volume of material which means that the volume of the bowl is advantageously distributed radially and consists mainly of the volume of the lateral angle of groove 34 in which the air and the fuel are mixed.

By virtue of the invention it is therefore possible, for the same volume, to produce a combustion bowl 18 of greater diameter.

Advantageously, the volume of the lateral annular groove 34 is, for example, smaller in the second angular sector (β) of the second portion 62 of the lower outer wall 58 which corresponds to the second region B in FIG. 1, which is generally predominantly air-rich and fuel-lean.

As a result, the complex geometry of the pip 38 makes it possible, in the second region B, to reduce the volume of air present with respect to the fuel and thus re-equalize the air/fuel ratio with a view to obtaining a more homogeneous air/fuel mixture.

In addition, the volume of the lateral annular groove 34 is greater in the first angular sector (α) of the first portion 60 of the lower outer wall 58 which corresponds to the first region A in FIG. 1, which on the whole, is radially opposite the second region B.

As a result, the complex geometry of the pip 38 makes it possible conversely to increase the volume of air present in this first region A which is generally predominantly fuel-rich, so as to obtain a more homogeneous mixture by re-equalizing the ratio between the air and the fuel therein.

As a preference, the height h of the upper horizontal face 56 of the lower cone frustum 38A that forms the base of the upper cone frustum 38B is substantially equal to half the total height H of the pip 38, that is to say to half the axial dimension, in the vertical direction, of the pip 38 measured from the bottom 36 of the bowl 18 to the upper part 70 of the pip 38.

Advantageously, the upper part of the pip 38 is machined by milling to form an upper face 70 that is preferably horizontal overall, or, as an alternative, convex.

The upper horizontal face 70 thus determines the total height H of the pip 38 in such a way that, upon injection, there is no interference between the jets 30 of fuel and the upper part of the pip 38, which lies vertically at a determined minimum distance away from the vertex S of the injected spray 28.

Advantageously, the combustion bowl 18 and the pip 38 are produced by milling the piston 14, in particular using a pneumatically-controlled milling machine.

Because the main axis of symmetry A-A of the combustion bowl 18 coincides with the vertical axis of symmetry X-X of the cylinder 12, the combustion bowl 18 and the lower cone frustum 38A are advantageously centered with respect to the cylinder 12 and to the piston 14.

As an alternative (which has not been depicted), the main axis of symmetry A-A of the combustion bowl 18 is offset from the axis X-X of the cylinder 12 so as to reduce the distance between the axis A-A of the bowl 18 and the reference vertical axis B-B passing through the vertex S of the injected spray 28.

Advantageously, the piston 14 comprises angular indexing means (not depicted) to allow the piston 14 to be mounted in the engine 10 in a determined operating position that can be indexed to suit the parameters of the injected spray 28 of the associated injector 26.

Advantageously, the engine 10 comprises means for producing an organized turbulent movement of the “swirl” type in the cylinder 12 during induction, so as to encourage the formation of a homogeneous air/fuel mixture.

1-10. (canceled)

11. A direct injection internal combustion engine comprising:
at least one cylinder of vertical axis in which a piston which, in its upper face, comprises a combustion bowl delimiting a lower part of a combustion chamber slides axially;
an injector offset from the axis and that sprays fuel in a form of an injected spray, substantially conical at the vertex, which includes plural asymmetric jets that cover paths of differing lengths before coming into contact with an internal wall of the combustion bowl that includes a lateral annular groove centered on a main axis of symmetry that meets a substantially horizontal bottom from which a pip extends vertically over a determined total height;
wherein the pip comprises:
a lower cone frustum including a base contained in the horizontal plane of the bottom and that is centered on the main axis of symmetry and having a vertex that is a point symmetric with the vertex of the injected spray with respect to the main axis of symmetry; and
an upper cone frustum including a base formed by the upper horizontal face of the lower cone frustum and having a vertex that corresponds to the vertex of the injected spray through which a reference vertical axis passes.

12. The engine as claimed in claim 11, wherein the lower cone frustum of the pip comprises a lower external wall with continuously varying convexness, comprising:
a first portion of the lower wall extending over a determined first angular sector, centered on the reference vertical axis, corresponding substantially to an angular sector of the injected spray formed by shorter-length jets; and
a second portion of the lower wall extending over a determined second angular sector, centered on the reference vertical axis, corresponding substantially to the angular sector of the injected spray formed by longer-length jets.

13. The engine as claimed in claim 12, wherein, in cross section on a vertical plane of section passing through the main axis, the first portion of the lower wall has a straight inclined profile of which a first gradient lies in continuation of the horizontal bottom and is determined so as to prevent the shorter-length jets from curling up on themselves in the direction of the internal wall of the groove.

14. The engine as claimed in claim 13, wherein, in cross section on a vertical plane of section passing through the main axis, the second portion of the lower wall has a straight inclined profile of which a second gradient is greater than the first gradient so that volume of the lateral groove at least in the second angular sector is smaller than volume of the lateral groove in the first angular sector.

15. The engine as claimed in claim 11, wherein the upper cone frustum of the pip includes an upper outer wall of continuously variable convexness determined so as to prevent interference between the jets of the injected spray and the upper external wall of the pip.

16. The engine as claimed in claim 11, wherein height of the upper horizontal face of the lower cone frustum is equal to half total height of the pip from the bottom of the bowl to the top of the pip.

17. The engine as claimed in claim 11, wherein total height of the pip is determined such that at a time of injection, there is no interference between the jets and the top of the pip.

18. The engine as claimed in claim 11, wherein the pip is produced by at least one milling operation performed on the piston.

19. The engine as claimed in claim 11, wherein the main axis of symmetry of the combustion bowl coincides with the vertical axis of the cylinder.

20. The engine as claimed in claim 11, wherein the piston comprises angular indexing means to allow the piston to be mounted in the engine in a determined operating position that is indexed according to parameters of the associated injected spray from the injector.
